(19) United States
(12) Patent Application Publication
(10) Pub. No.: US 2012/0150661 A1
(43) Pub. Date: Jun. 14, 2012

(54) System and Method to Enable any Internet-Compatible Advertisement to be Fully Shareable to a Wide Variety of Social Media Networks and Platforms

(75) Inventors: Bill DeStein, Pleasanton, CA (US); Michal Bortnik, Palo Alto, CA (US); Qinchao Zhu, San Jose, CA (US); Stephen Mooney, New York, NY (US)

(73) Assignee: LOCKERZ, INC, Seattle, WA (US)

(21) Appl. No.: 13/312,235

(22) Filed: Dec. 6, 2011

Related U.S. Application Data
(60) Provisional application No. 61/459,120, filed on Dec. 6, 2010.

(51) Int. Cl. G06Q 30/02

(52) U.S. Cl. 705/14.72

(57) ABSTRACT

A system and method for creating shareable Internet-based advertisements includes an administration console receiving data related to an Internet-based advertisement, and configuring an overlay to provide on top of the Internet-based advertisement. A database operatively connected to the administration console stores data and code related to the overlay and the Internet-based advertisement. A share tag is applied to the Internet-based advertisement. Upon activation of the share tag, a share tag server retrieves the stored data and code and displays the overlay on the Internet-based advertisement as an expanded share tag. Upon activation of a share feature on the expanded share tag, the share tag server provides, to a desired social media network server, the stored data needed to display the Internet-based advertisement on the user's social media network page. The Internet-based advertisement is displayed on the user's social media network page, and may be further shared by others.

### CROSS-REFERENCE TO RELATED APPLICATIONS

This patent application claims the benefit of co-pending U.S. Provisional Patent Application No. 61/459,120, filed on Dec. 6, 2010, the entire disclosure of which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention is directed generally toward Internet-compatible shareable advertisements and, more particularly, toward a system and method for allowing any Internet-compatible advertisement, including those not programmed to be shareable, to be fully shareable to social media networks across a variety of platforms.

### BACKGROUND OF THE INVENTION

Internet-based advertisement sharing has generally focused on either: (1) sharing links to the advertisements on a content site; or (2) programming/reprogramming the code within an advertisement's creative file, typically an FLA file (see e.g., FIG. 8), to make the advertisement shareable. The FLA file is the Flash source file that contains all of the animations and graphics that are displayed on the web pages. However, each of these prior art approaches have their own drawbacks.

With respect to approach (1), one of the drawbacks is that once the advertisement is removed from the web page where it was originally displayed, the user and subsequent generations of sharers have shared only a now dead link. Accessing the link will not access the advertisement, since it has been removed from the web page.

With respect to approach (2), a key limitation is that the process of altering the code within the creative file to make an advertisement shareable is a custom process that requires a software engineer's time for each advertisement at either the building or the retrofitting stage. Software engineers or developers are required as code needs to be actually written inside of the ad unit to make it shareable. This requires more lead time from the advertiser. The custom nature of the work, currently required by the existing art, to make an advertisement shareable can significantly increase the cost of an online advertising campaign. For example, if it is desired to have the advertisements change over the course of a campaign, each advertisement will need to go through the same cumbersome cycle of having code actually written into the ad unit to make the advertisement shareable. This can significantly increase the cost and difficulty of running an advertising campaign.

What is needed, therefore, are improved techniques for making Internet-based advertisements shareable quickly and inexpensively.

The presently disclosed system and method is directed toward overcoming one or more of the above-mentioned problems.

### SUMMARY OF THE INVENTION

To address the above drawbacks, as well as to facilitate other advertising-sharing improvements, the presently disclosed system and method provides a mechanized solution to make Internet-based advertisements fully shareable by adding a share tag to the advertisement tag (see e.g., FIG. 3) layered on top of the creative file, without need for an engineer to alter the code within the creative file.

The presently disclosed system and method allows virtually any Internet-compatible advertisement, or other electronic advertisement, including those not programmed to be shareable, to be made fully and permanently shareable to various social media networks across a variety of platforms. The presently disclosed system and method also allows for a wide variety of interactive information to be displayed within the share tag. The inventive share tag is embedded within, or applied to, an advertisement and enlarges when a user hovers over the share-tag button. The information that the share tag displays can be anything the client requests, and may, for example, include information that encourages users to share (e.g., real-time updates of the number of shares, number of times the advertisement has been viewed, inclusion of the “follow” feature, inclusion of the “like” sentiment, etc.).

In accordance with the present invention, a system for creating shareable Internet-based advertisements is provided. The system includes an administration console receiving data related to an Internet-based advertisement from a client, the administration console configuring an overlay to provide on top of the Internet-based advertisement, a database operatively connected to the administration console for storing the data and code related to the overlay and the Internet-based advertisement, wherein the administration console generates a share tag that is applied to the Internet-based advertisement, the share tag comprising a script reference pointing to the stored data and code stored in the database, and at least one share tag server retrieving the stored data and code and displaying the overlay on the Internet-based advertisement as an expanded share tag upon a user activating the share tag of the Internet-based advertisement published on a content website. Upon the user activating a share feature on the expanded share tag, the at least one share tag server provides, to a desired social media network server, the stored data needed to display the Internet-based advertisement on the user's social media network page. The Internet-based advertisement is then displayed on the user's social media network page, and may be further shared by others using the social media network's sharing mechanism.

The data and code relating to the overlay includes text and image data for generating the overlay as the expanded share tag and code for executing the overlay as the expanded share tag on the content website.

In another form, the data and code relating to the overlay includes text and image data for generating the overlay as the share tag and code for executing the share tag when a user clicks on or mouses over the share tag, and further includes text and image data for further generating the overlay as the expanded share tag and code for executing the overlay as the expanded share tag on the content website.

In one form, the code includes JavaScript.

The Internet-based advertisement will generally include a publisher tag, an ad tag and a creative file. In one form, the share tag is applied to the publisher tag or the ad tag of the Internet-based advertisement. As a result, the stored data and code relating to the overlay are readily modifiable without requiring modification of the creative file of the Internet-based advertisement.

In an alternate form, wherein the share tag is applied to the Internet-based advertisement as a position other than a creative file of the Internet-based advertisement. Again, as a result, the stored data and code relating to the overlay are readily modifiable without requiring modification of the creative file of the Internet-based advertisement.

Activation of the share tag generally is accomplished by a user hovering a pointer over the share tag or clicking on the share tag provided on the Internet-based advertisement.

In accordance with the present invention, a method for creating shareable Internet-based advertisements is provided. The method generally includes the steps of receiving, at an administration console, data related to an Internet-based advertisement from a client, configuring, by the administration console, an overlay to provide on top of the Internet-based advertisement, storing data and code relating to the overlay and the Internet-based advertisement in a database, generating a script reference as a share tag, the share tag pointing to the stored data and code stored in the database, applying the share tag to the Internet-based advertisement, upon activating, by a user, the share tag in the Internet-based advertisement published on a content website, retrieving the stored data and code from the database to display the overlay as an expanded share tag on the content website, upon selecting, by a user, a share feature in the expanded share tag, retrieving, by a desired social media network server, the stored data needed to display the Internet-based advertisement on the user's social media network page, and displaying the Internet-based advertisement on the user's social media network page. The Internet-based advertisement may then be shared by subsequent generations using the social media network's sharing mechanism.

The Internet-based advertisement generally includes a publisher tag, an ad tag and a creative file. In one form, the share tag is applied to the publisher tag or the ad tag of the Internet-based advertisement. Accordingly, the stored data and code relating to the overlay are readily modifiable without requiring modification of the creative file of the Internet-based advertisement.

The data and code relating to the overlay includes text and image data for generating the overlay as the expanded share tag and code for executing the overlay as the expanded share tag on the content website.

In another form, the data and code relating to the overlay includes text and image data for generating the overlay as the share tag and code for executing the share tag when a user clicks on or mouses over the share tag, and further includes text and image data for further generating the overlay as the expanded share tag and code for executing the overlay as the expanded share tag on the content website.

In one form, the code includes JavaScript.

The stored data and code for displaying the overlay as the expanded share tag on the content website are retrieved from the database via at least one share tag server associated with the database. Similarly, the stored data, including the share tag as the script reference, needed to display the Internet-based advertisement on the user's social media network page are retrieved from the database via at least one share tag server associated with the database.

In one form, a method for creating shareable Internet-based advertisements is provided, which includes the steps of adding, by an administration console, a share tag as a script reference to an existing Internet-based advertisement, storing, in a database, data and code relating to the Internet-based advertisement and an overlay to provide on top of the Internet-based advertisement when the share tag is activated, the share tag pointing to the stored data and code, upon activating, by a user, the share tag in the Internet-based advertisement published on a content website, retrieving the stored data and code from the database to display the overlay as an expanded share tag on the content website, upon selecting, by a user, a share feature in the expanded share tag, retrieving, by a desired social media network server, the stored data from the database needed to display the Internet-based advertisement on the user's social media network page, and displaying the Internet-based advertisement on the user's social media network page.

It is an object of the present invention to provide a system and method by which Internet-based advertisements can be fully shareable.

It is a further object of the present invention to provide a system and method by which virtually any Internet-based advertisement can be fully shareable to a wide variety of social media networks and platforms.

It is yet a further object of the present invention to provide a system and method by which Internet-based advertisements can be made fully shareable quickly and inexpensively.

It is a still a further object of the present invention to provide a system and method by an advertising campaign can change ads during the course of the campaign while, at the same time, making each of the ads fully shareable quickly and inexpensively.

Various other objects, aspects and advantages of the presently disclosed system and method can be obtained from a study of the specification, the drawings, and the appended claims.

### BRIEF DESCRIPTION OF THE DRAWINGS

Additional features, details and advantages of the presently disclosed system and method can be derived from the following description of exemplary embodiments on the basis of the accompanying drawings, in which:

FIG. 1 illustrates a share tag embedded in an advertisement displayed on a web page in accordance with an embodiment of the present invention;

FIG. 2 illustrates an a pop-up window associated with a social media site with which the user wishes to share an ad in accordance with an embodiment of the present invention;

FIG. 3 illustrates an advertisement shared to a user's social media network in accordance with an embodiment of the present invention;

FIG. 4 is a flow chart illustrating how the share tag works from a user's perspective in accordance with an embodiment of the present invention;

FIG. 5 is a flow chart illustrating how the share tag works from a client's perspective in accordance with an embodiment of the present invention;

FIG. 6 is a diagram illustrating campaign information input by a client in the development of a shareable advertisement in accordance with an embodiment of the present invention;

FIG. 7 is a diagram illustrating the share tag added to the publisher or ad tag in order to make an advertisement shareable in accordance with an embodiment of the present invention;

FIG. 8 illustrates the various data-package components that make up an electronic advertisement in accordance with an embodiment of the present invention;

FIG. 9 is a data flow diagram of an inventive system for performing the inventive method in accordance with an embodiment of the present invention;

FIG. 10 illustrates an advertisement having various types of expanded share tags and share tags as viewed by a user; and

FIG. 11 sets forth the programming code for the share tag example depicted in FIG. 10B.

### DETAILED DESCRIPTION OF THE INVENTION

Embodiments of the present invention will be readily understood from the following detailed description in conjunction with the accompanying drawings. To facilitate this description, like reference numerals designate like structural elements. Embodiments of the invention are illustrated by way of example, and not by way of limitation, in the figures of the accompanying drawings.

Embodiments of the present invention include systems and methods for allowing any Internet-compatible advertisement, including those not programmed to be shareable, to be fully shareable to social media networks across a variety of platforms. Various embodiments of the system and method of the present invention include the following components, which will be described hereafter in more detail. As used herein, “AdNectar” generally refers to the remote host of the inventive system and is used to distinguish inventive aspects of the disclosed system and method from those already existing. Although, there may be times throughout this disclosure where the component is referred to without the preceding “AdNectar” term.

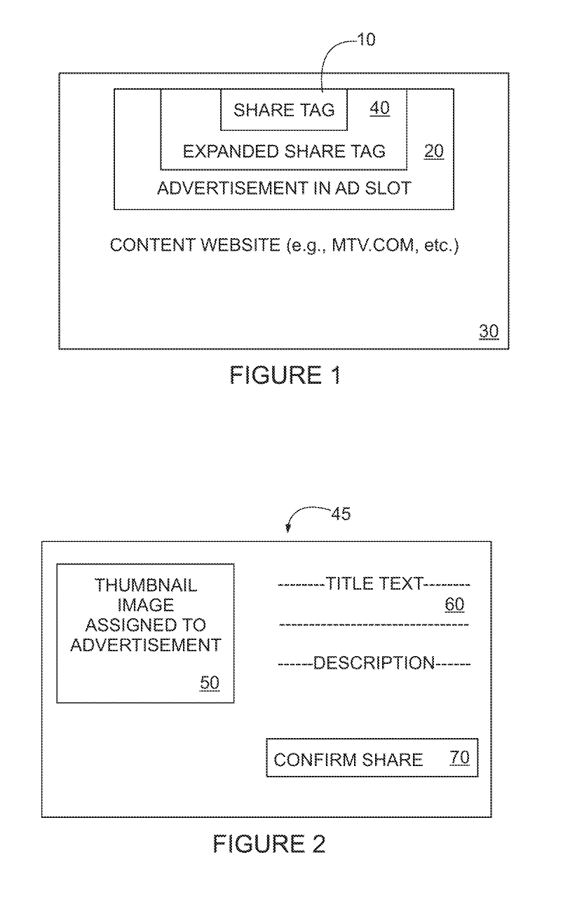

AdNectar share tag (10 in FIG. 1): An application added to the advertisement's ad tag, without altering the advertisement's creative file, that allows the advertisement to be fully shareable. The share tag generally appears as a small icon embedded in an electronic advertisement. When a mouse cursor is placed, or hovers, over the share tag icon or, alternatively, when the share tag icon is clicked, the share tag expands to present additional information and user controls.

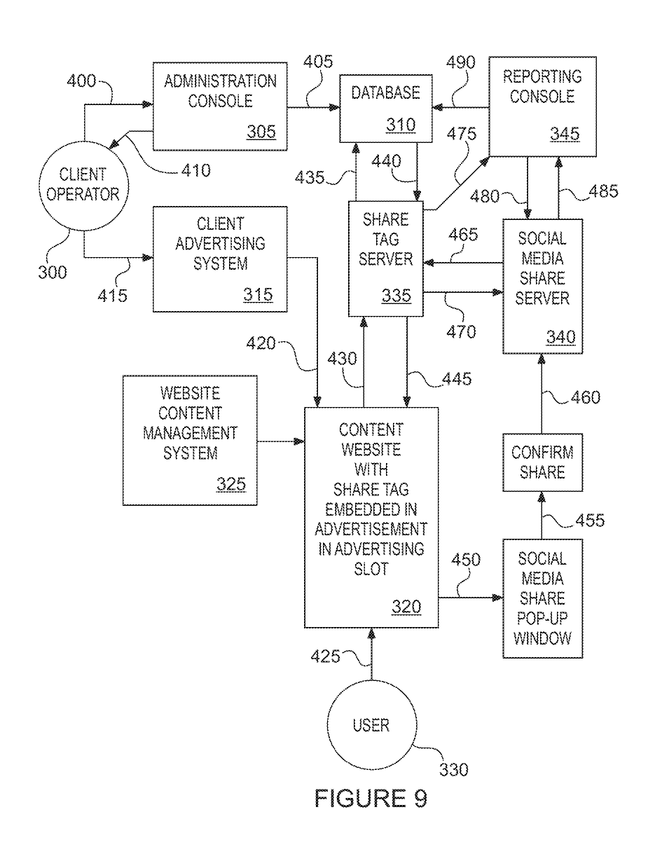

AdNectar self serve share tag administration console (305 in FIG. 9): Allows clients to both enter and update any thumbnail images and text that they want to accompany the advertisement to be shared when it appears in a user's social media news feed. The information (text, images, graphics, etc.) to be displayed may be updated or altered by the client in real time without having to go through the expensive and time consuming process of having code actually written into the ad unit. This is a particular benefit for clients with multiple stage campaigns with different messages before and after a certain time or date (e.g., messaging before and after a theatrical release).

AdNectar share tag server cluster (335 in FIG. 9): This server cluster facilitates the sharing of the full advertisement to a user's social media news feeds by interfacing with the AdNectar database, when instructed to do so by the AdNectar share tag application, and relaying the data needed to permanently display an advertisement to the social media servers.

AdNectar database (310 in FIG. 9): This database permanently stores (a) data required to display any advertisement still being shared, and (b) reporting information (e.g., number of shares initiated, number of shares confirmed by users, etc.) gathered by the AdNectar reporting console.

AdNectar reporting server console (345 in FIG. 9): Gathers information related to the scope and success of interactivity and sharing for any particular advertisement using information-gathering hooks embedded in the AdNectar share tag application.

A particular embodiment of the present invention will now be described. The embodiment is exemplary only, and does not limit the present invention in any way. The embodiment may, for example, be implemented by software executing on a computer or computers. One skilled in the art will appreciate that the present invention may be implemented in a number of ways.

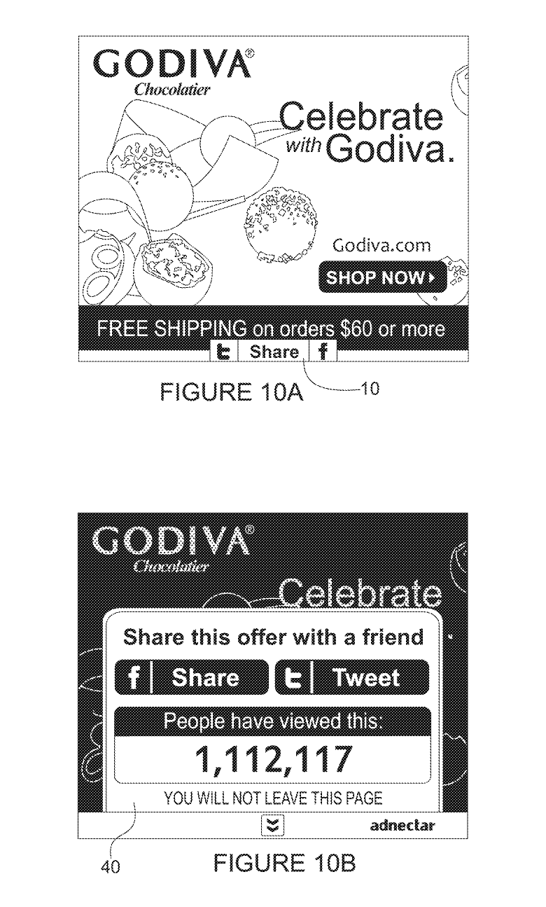

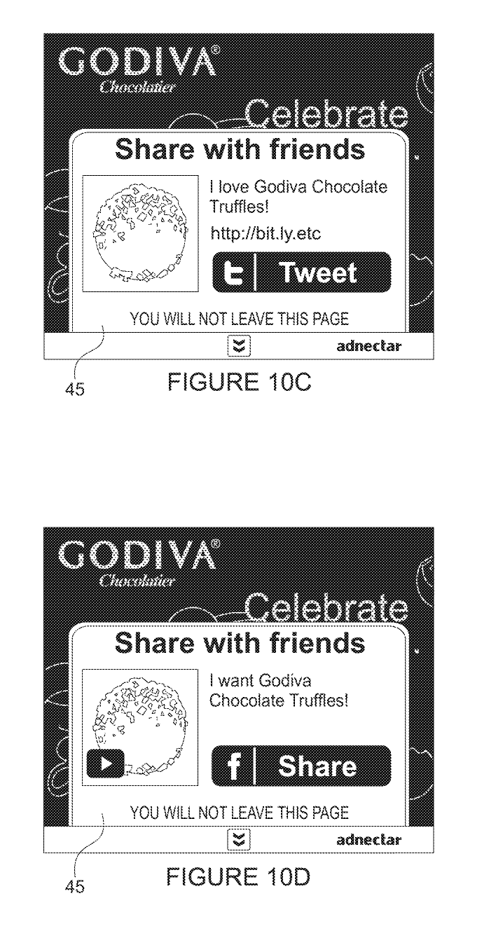

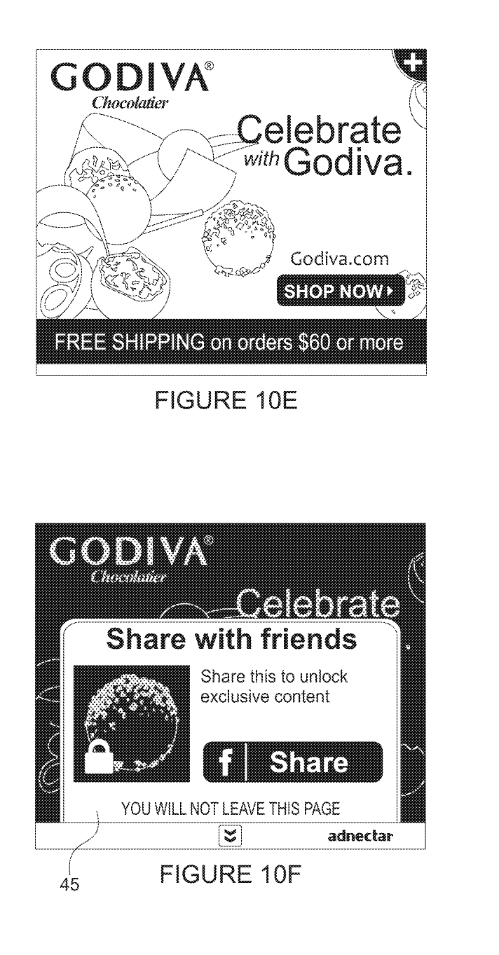

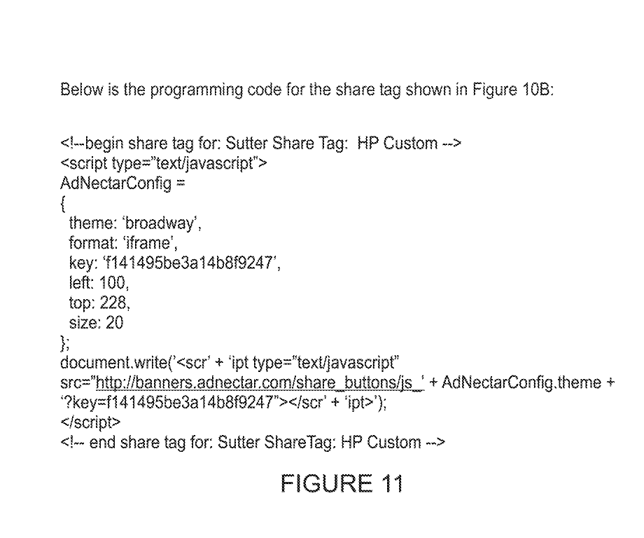

FIG. 1 illustrates a share tag 10 embedded in an advertisement 20 displayed on a web page 30. A user sees the share tag 10 embedded in the advertisement 20 he/she wishes to share. When the user hovers over, or clicks on, the share tag 10, it expands, as show at 40. The expanded share tag 40 allows the user to click to share the advertisement 30 to various social media networks (e.g., Facebook, Twitter, etc.). The expanded tag 40 also displays any content the client requests (see e.g., FIG. 10). This content can include, but is not limited to, information to encourage sharing of the advertisement 20, such as the number of times the advertisement 20 has been shared (updated in real time), or the number of times the advertisement 20 has been viewed, or inclusion of the “follow” feature, or inclusion of the “like” sentiment, etc.

FIG. 10 illustrates an advertisement having various types of expanded share tags and share tags. For example, FIG. 10E illustrates a typical non-shareable Internet-based advertisement without a share tag. FIG. 10A illustrates the same advertisement now including a share tag located at the bottom center of the advertisement. When a user hovers over, or clicks on, the share tag 10 shown in FIG. 10A, an expanded share tag 40 appears, as shown in FIG. 10B. FIG. 10B illustrates an expanded share tag 40 which displays information concerning the number of times the advertisement has been viewed. (FIG. 11 sets forth the programming code for the share tag example depicted in FIG. 10B). FIG. 10C illustrates an exemplary pop-up window 45 that appears when the user clicks on the “Twitter” share button in FIG. 10B. FIGS. 10D and 10F illustrates variations of exemplary pop-up windows 45 that can appear when the user clicks on the “Facebook” share button in FIG. 10B. The pop-up windows 45 in FIGS. 10C and 10D each include a thumbnail image and associated text provided by the client. Both the image and the text are readily modified using the inventive system and method. FIG. 10F illustrates a pop-up window 45 having secure content that is only unlocked once the ad is shared. This feature can be used as an incentive to share ads.

Once the user clicks on the “share” button in the expanded share tag 40, as shown in FIG. 2, the pop-up screen 45 appears which will generally include a thumbnail image 50 assigned to the advertisement, an area 60 for the client to include text (title, description, etc.), and a confirm share button 70 associated with the social media site that the user wishes to share to (e.g., Facebook, Twitter, etc.). If the user is not signed into their social media account, they can sign in through the same pop-up window 45 and then confirm the share.

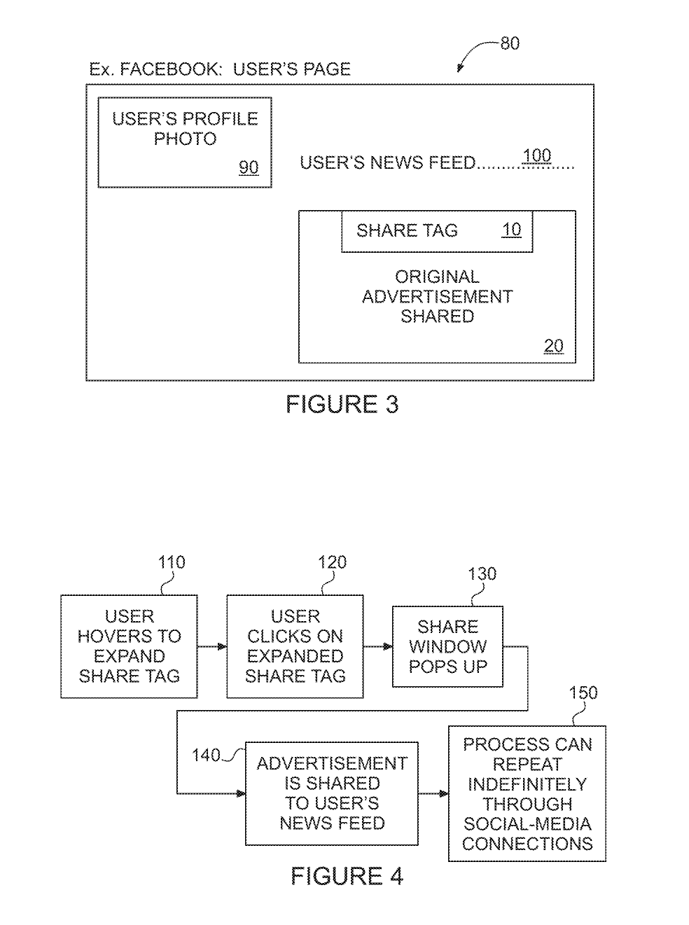

FIG. 3 is a diagram of a user's social media page 80 (e.g., Facebook page). Among other things, the user's social media page 80 includes a user's profile photo 90 and a news feed area 100. Upon clicking to share the advertisement 20, the original advertisement 20 will be permanently shared to the user's news feed 100, and can be shared by any subsequent generations of users using the social media network sharing mechanism.

FIG. 4 illustrates how the AdNectar share tag 10 works from a user's perspective. In step 110, the user hovers over, or clicks on, the share tag, which then expands as described above. The user then clicks on the share button in the expanded share tag 40, at step 120, and the share pop-up window 45 appears, at step 130. The user confirms the share in the pop-up window 45, and the advertisement 20 is shared to the user's news feed 100, at step 140. The process can then repeat itself indefinitely by other users through social media connections, at step 150.

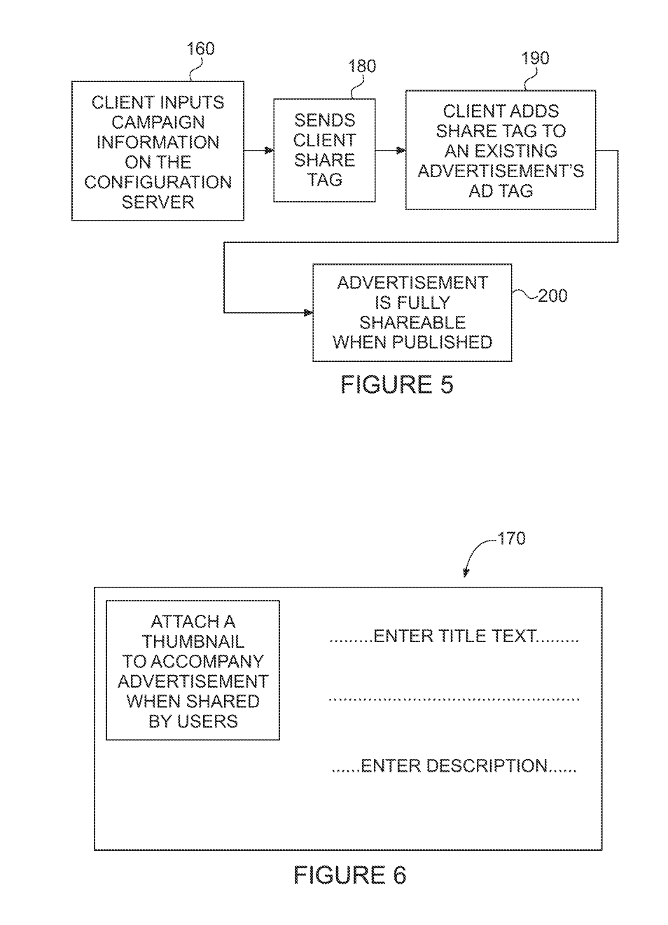

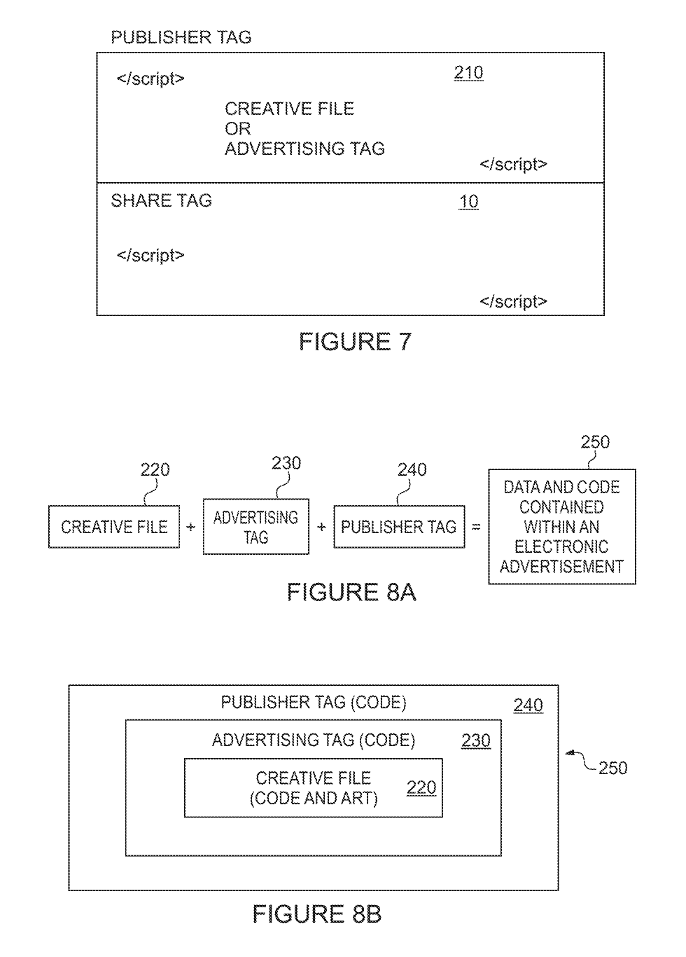

FIG. 5 illustrates how the AdNectar share tag 10 works from a client's perspective. At step 160, the client inputs campaign information onto the AdNectar configuration server. For example, as shown in FIG. 6, the client representative inputs the campaign information (show at 170, which includes the advertisement's creative content, as well as the text, description and images (e.g., thumbnail images) to accompany an advertisement when it is shared by users) into the configuration program housed on the AdNectar servers. Referring back to FIG. 5, the inventive system and method then sends the client a share tag, at step 180. The share tag is programmed to allow the campaign information 170 input by the client to be updated in real time by the client, even after the advertisement has been published. As shown in FIG. 7, the client receives the share tag 10, which is a software file containing code to add to their ad tag 210 in order to make any advertisement fully shareable. Referring back to FIG. 5, the client adds the share tag to an existing advertisement's ad tag, at step 190. The advertisement is then fully shareable when published, at step 200. The client adds the share tag 10 before publication, and the advertisement is now fully shareable and the information that accompanies the sharing of the advertisement (e.g., campaign information) can be updated in real time by the client without the need to reconfigure, or write new code into, the creative file.

FIG. 8 illustrates the various data-package components that make up an electronic advertisement. The data/programming code of components of an electronic advertisement without a share tag can be conceptualized in two ways. As shown in FIG. 8A, an advertisement can be considered as the sum of its parts. The advertisement generally consists of a creative file (code and art) 220, plus an ad tag (code) 230, plus a publisher tag (code) 240. All of these components comprise the data and code contained within an electronic advertisement, at 250. Alternately, as shown in FIG. 8B, an advertisement can be considered a sequence of envelopes. The advertisement generally consists of a publisher tag (code) 240, into which an ad tag (code) 230 is enveloped. The creative file (code and art) 220 is enveloped into the ad tag 230, or can be enveloped into the publisher tag 240. The creative file 220 may also include a creative tag or tags into which the creative file 220 in enveloped into. In order to provide for the ad to be shareable, the creator need only reserve a space in the publisher tag or ad tag for insertion of the AdNectar share tag 10.

FIG. 9 illustrates the various components of the inventive share tag system and method and how they interact. In the embodiment shown in FIG. 9, a client 300, typically an advertising agency, uploads data related to an electronic advertisement (e.g., IMG, SWF, etc.), and enters any text and/or additional content that is to appear alongside the advertisement when the advertisement is shared to a social media newsfeed, to the AdNectar administration console 305, at step 400. As previously noted, the client needs to leave a space to put the share tag in their advertisement. The data related to the electronic advertisement includes, for example, the type of ad campaign, the location of the share tag, the theme of the ad (color, font, etc.), the text, description, messaging and images the client wants to appear in the ad when the ad is shared or a user mouses over the share button, etc. In one form, the client enters this information via a self-serve interface.

All information that was uploaded to the AdNectar administration console 305 is then stored in the AdNectar database 310, which is housed on the AdNectar server cluster 335, at step 405. The client 300 receives back a share tag (e.g., a script reference) from the AdNectar administration console, at step 410. All of the data needed to display the advertisement in perpetuity is gathered by the AdNectar servers 335, and the share tag, which is to be embedded in the advertisement, retrofits the previously non-shareable ad to be fully shareable across a broad spectrum of electronic media platforms without requiring any of the flash code within the advertisement's creative file to be rewritten. This allows the ad to be made fully shareable post creation.

The received share tag is uploaded by the client 300 and added to the advertising tag (“ad tag”), both of which are attached to the advertisement's creative file (see FIG. 8B for relationship of tags) within the client's ad system 315, at step 415. From the client's ad system 315, the advertisement with the embedded share tag is published to ad slots on various Internet content sites 320 (e.g., MTV.com, CNN.com, Google.com, etc.), at step 420. The content website 320 is conventionally controlled by a website content management system 325.

A user 330 viewing the Internet page containing the advertisement hovers over, or clicks on, the share tag embedded in the advertisement, at step 425. The share tag, which is a script reference, then calls out to the AdNectar share tag server cluster 335 for instructions, at step 430. The AdNectar share tag server cluster 335 then requests, at step 435, and receives, at step 440, all of the stored data and code (e.g., JavaScript) needed for sharing the advertisement and any accompanying ad campaign text and/or multimedia content from the AdNectar database 310. This information is used by the AdNectar share tag server 335 to expand the ad located at the content website 320, at step 445. All of the information received is also retained on the AdNectar share tag server 335 for a subsequent step.

The code for creating the share tag and the expanded share tag may be downloaded in one or two steps. In one form, the share tag script runs when the content, or publisher, page is loaded and adds a script reference to the Document Object Module (“DOM”). That script reference causes JaveScript (phase 1 JavaScript) to be loaded from the AdNectar server 335 to the content website 320. The phase 1 JavaScript finds the ad within the DOM and positions the share tag on top of the ad. The phase 1 JavaScript also registers a mouseover or click event handler for that share tag or icon, and sends events to the AdNectar server 335, such as, for example, “ad tag loaded”, “mouseover”, “click”, etc.

When the mouseover or click handler gets control, namely, when a user mouses over or clicks on the share tag, the handler loads additional JavaScript (phase 2 JavaScript) from the AdNectar server 335 to the content website 320. The phase 2 JavaScript displays the expanded share tag overlay, and handles all of the interaction with the social network popups, and handles additional event reporting to the AdNectar servers 335 as will be more fully described hereafter.

The phase 1 and phase 2 JavaScript can be loaded at the same time in advance of a mouseover or click event. The advantage here is that the mouseover or click event responds more quickly. The disadvantage is that most of the time there is no mouseover or click event, so loading the phase 2 JavaScript at the outset consumes network bandwidth and slows page load unnecessarily in most cases.

Using the received data and code, the share tag on the content website 320 expands to display the option to share the advertisement to social media network (e.g., Facebook, Twitter, etc.). The expanded tag also display content related to the advertisement (text and/or images) and/or user interactions with the advertisement (e.g., how many users have already shared the advertisement, the number of times the advertisement has been viewed, inclusion of the “follow” feature, inclusion of the “like” sentiment, etc). The user 330 then clicks the share button on the expanded share tag to share the advertisement to one of the user's social media networks, at step 450.

A pop-up window, originating from the social-media server (e.g., Facebook, Twitter, etc.), will then ask the user 330 to confirm that he/she wishes to share to his/her news feed, at step 455. If the user is not logged in, he/she will need to log in through this same window before confirming.

Upon the user 330 confirming that they wish to share, the social media server 340 (e.g., Facebook, Twitter, etc.), reads the instructions received within the share tag application, at step 460. The social media server 340 calls out to the AdNectar share tag server 335 cluster for further instruction and data, at step 465. The AdNectar share tag server cluster 335 delivers all of the data (e.g., IMG, SWF, text, etc.) needed to display the advertisement on the social media user's newsfeed in perpetuity, at step 470. Previous advertisement sharing mechanisms allowed only a link to a content page where the advertisement was hosted to be shared to a newsfeed, not the advertisement itself. Once the advertisement was removed from the content page, the user was left with a dead link. The AdNectar server cluster 335 also provides information concerning the shared ad to the AdNectar reporting console 345, at step 475. The advertisement displayed on the social media user's newsfeed may then be shared by others using the social media network's sharing mechanism.

Information-gathering hooks embedded within the AdNectar share tag application collect sharing data which is typically useful to clients in assessing the success of a campaign, including, but not limited to, the number of impressions and interactions with the advertisement, how many times an advertisement was shared, the number of confirmations it received, etc., at step 480. The collected information is then relayed to the AdNectar reporting console 345, at step 485, which is then send to the AdNectar database 310 for permanent storage, at step 490. In this manner, the inventive system and method can track information useful to a client for the client's advertising campaign.

The various steps discussed about can be repeated indefinitely by other users accessing the shared ad on the user's social media network. The only difference being that each share in this repeating cycle would originate with a social media user sharing an advertisement from another social media user's newsfeed instead of from the content website 320 where the advertisement was originally placed. All other steps would remain the same.

The inventive system and method provides a virtually non-exhaustive list of variations and additional functions that can be performed. These include, but are not limited to:
The overlaying of social data (e.g., the number of shares, the number of friends who viewed the advertisement, the number of friends who liked the advertisement, etc.) collected through end user interactions with the share tag in the share tag user interface seen by other users.
The sharing of content related to the advertisement's creative content in addition to, or instead of, the advertisement's creative content (e.g., coupons, offers, exclusive content, virtual goods, etc.). These can be changed in real time using the inventive system and method without the entire ad having to be recreated and the share tag coded within.
Configuring the placement of the share tag user interface to work with the design of any advertisement (i.e., not just to any particular corner or edge). The placement of the share tag can be easily and inexpensively changed in real time as advertisements chance over the course of an ad campaign.
The tracking additional data such as, but not limited to, share tag impressions, share tag interactions, interactions with the shared asset in the newsfeed, shares from the newsfeed, etc.
The detection of multiple advertisements contained within a creative file assigned to one ad tag, so that the user shares the advertisement they intend to share to their social-media news feed. For example, an advertiser might have four different advertisements for the same or multiple products that are linked to the same ad tag and alternately appear in one advertisement slot on a content site's homepage. With the inventive system and method, the user can pick the particular ad they wish to share.
The AdNectar share tag described herein can achieve the same beneficial result described in this application by being added to the creative file itself (see e.g., FIG. 8B). The AdNectar share tag can also achieve the same result, including the detection of multiple advertisements within a creative file, by being added to any tag, other than the ad tag, into which the creative file has been enveloped.
The AdNectar share tag supports adding social actions other than sharing, such as, but not limited to, “following” and/or “liking”, both/all of which can be carried out without leaving the web page containing the advertisement.
The AdNectar share tag supports dropping browser cookies related to the various actions a user can perform in the AdNectar share tag user interface. This functionality enables cookie-based ad retargeting which are directed at improving the results of an advertising campaign.

The presently disclosed system and method offers various advantages and variations over the prior art approaches, some of which include, but are not limited to:
Allows Internet-based advertisements which are not programmed to be shareable to be retrofitted post-creation for direct and easy shared by anyone via electronic social media.
   Some prior art approaches require users to share a link to an advertisement on a web page. The disadvantage of sharing only a link to the web page that is hosting an advertisement is that once that advertisement is removed from the linked page, the user has shared only a now-dead link.
   Other prior are approaches require, in order to make the ad itself directly shareable, retrofitted reprogramming of the advertisement's Flash code. The requires the assistance of software engineers or developers, and is a time consuming and expensive process.
What is shared by users is the electronic advertisement itself, not a link to it. Thus, the disclosed system and method allows for creative persistence (in that users and their network can always see what was shared).
The dynamic configuration of the disclosed system and method allows clients, typically advertising agencies, to easily create and update, in real time, messages to accompany their advertisements when users share them via social media.
The disclosed system and method allows users to directly share advertisements to multiple destinations (e.g., Facebook, Twitter, e-mail, etc.).
The disclosed system and method allows for all sharing of advertisements, including all generations of sharing (e.g., first generation user sharing of an advertisement found on a content website to Facebook; second generation second user sharing of that advertisement from Facebook to a Twitter feed; third generation third user sharing of that advertisement from Twitter to e-mail; etc.), to be both fully traceable and optimizable.

While the presently disclosed system and method has described herein with particular reference to the drawings, it should be understood that various modifications could be made without departing from the spirit and scope of the present invention. Those skilled in the art will appreciate that various other modifications and alterations could be developed in light of the overall teachings of the disclosure. The presently preferred embodiments described herein are meant to be illustrative only and not limiting as to the scope of the invention which is to be given the full breadth of the appended claims and any and all equivalents thereof. Additionally, the disclosure of a range of values is a disclosure of every numerical value within that range.

I/we claim:

1. A system for creating shareable Internet-based advertisements comprising:
an administration console receiving data related to an Internet-based advertisement from a client, the administration console configuring an overlay to provide on top of the Internet-based advertisement;
a database operatively connected to the administration console for storing the data and code related to the overlay and the Internet-based advertisement, wherein the administration console generates a share tag that is applied to the Internet-based advertisement, the share tag comprising a script reference pointing to the stored data and code stored in the database; and
at least one share tag server retrieving the stored data and code and displaying the overlay on the Internet-based advertisement as an expanded share tag upon a user activating the share tag of the Internet-based advertisement published on a content website,
wherein, upon the user activating a share feature on the expanded share tag, the at least one share tag server provides, to a desired social media network server, the stored data needed to display the Internet-based advertisement on the user's social media network page.

2. The system of claim 1, wherein the Internet-based advertisement is displayed on the user's social media network page.

3. The system of claim 1, wherein the data and code relating to the overlay comprises text and image data for generating the overlay as the expanded share tag and code for executing the overlay as the expanded share tag on the content website.

4. The system of claim 3, wherein the code comprises JavaScript.

5. The system of claim 1, wherein the Internet-based advertisement includes a publisher tag, an ad tag and a creative file, and wherein the share tag is applied to the publisher tag or the ad tag of the Internet-based advertisement.

6. The system of claim 5, wherein the stored data and code relating to the overlay are readily modifiable without requiring modification of the creative file of the Internet-based advertisement.

7. The system of claim 1, wherein the share tag is activated by a user hovering a pointer over the share tag or clicking on the share tag provided on the Internet-based advertisement.

8. The system of claim 1, wherein the stored data and code relating to the overlay are readily modifiable without requiring modification of a creative file of the Internet-based advertisement.

9. The system of claim 1, wherein the share tag is applied to the Internet-based advertisement as a position other than a creative file of the Internet-based advertisement.

10. A method for creating shareable Internet-based advertisements comprising the steps of:
receiving, at an administration console, data related to an Internet-based advertisement from a client;
configuring, by the administration console, an overlay to provide on top of the Internet-based advertisement;
storing data and code relating to the overlay and the Internet-based advertisement in a database;
generating a script reference as a share tag, the share tag pointing to the stored data and code stored in the database;
applying the share tag to the Internet-based advertisement;
upon activating, by a user, the share tag in the Internet-based advertisement published on a content website, retrieving the stored data and code from the database to display the overlay as an expanded share tag on the content website;
upon selecting, by a user, a share feature in the expanded share tag, retrieving, by a desired social media network server, the stored data needed to display the Internet-based advertisement on the user's social media network page; and
displaying the Internet-based advertisement on the user's social media network page.

11. The method of claim 10, wherein the Internet-based advertisement includes a publisher tag, an ad tag and a creative file, and wherein the share tag is applied to the publisher tag or the ad tag of the Internet-based advertisement.

12. The method of claim 11, wherein the stored data and code relating to the overlay are readily modifiable without requiring modification of the creative file of the Internet-based advertisement.

13. The method of claim 10, wherein the data and code relating to the overlay comprises text and image data for generating the overlay as the expanded share tag and code for executing the overlay as the expanded share tag on the content website.

14. The method of claim 13, wherein the code comprises JavaScript.

15. The method of claim 10, wherein the stored data and code for displaying the overlay as the expanded share tag on the content website are retrieved from the database via at least one share tag server associated with the database.

16. The method of claim 10, wherein the stored data, including the share tag as the script reference, needed to display the Internet-based advertisement on the user's social media network page are retrieved from the database via at least one share tag server associated with the database.

17. A method for creating shareable Internet-based advertisements comprising the steps of:
adding, by an administration console, a share tag as a script reference to an existing Internet-based advertisement;
storing, in a database, data and code relating to the Internet-based advertisement and an overlay to provide on top of the Internet-based advertisement when the share tag is activated, the share tag pointing to the stored data and code;
upon activating, by a user, the share tag in the Internet-based advertisement published on a content website, retrieving the stored data and code from the database to display the overlay as an expanded share tag on the content website;
upon selecting, by a user, a share feature in the expanded share tag, retrieving, by a desired social media network server, the stored data from the database needed to display the Internet-based advertisement on the user's social media network page; and
displaying the Internet-based advertisement on the user's social media network page.

18. The method of claim 17, wherein the stored data and code relating to the overlay are readily modifiable without requiring modification of a creative file of the Internet-based advertisement.

19. The method of claim 17, wherein the data and code relating to the overlay comprises text and image data for generating the overlay as the expanded share tag and code for executing the overlay as the expanded share tag on the content website.

20. The method of claim 19, wherein the code comprises JavaScript.

21. The method of claim 17, wherein the stored data and code for displaying the overlay as the expanded share tag on the content website are retrieved from the database via at least one share tag server associated with the database, and wherein the stored data, including the share tag as the script reference, needed to display the Internet-based advertisement on the user's social media network page are retrieved from the database via at least one share tag server associated with the database.
